(19) United States
(12) Patent Application Publication
(10) Pub. No.: US 2021/0114925 A1
(43) Pub. Date: Apr. 22, 2021

(54) CRACK-FREE GLASS SUBSTRATE CUTTING AND THINNING METHOD

(71) Applicants: BSP CO., LTD., Anyang-si (KR); JOONGWOO M-TECH CO., LTD., Ansan-si (KR)

(72) Inventors: Hong Jin PARK, Anyang-si (KR); Sung Soo PARK, Yongin-si (KR)

(73) Assignees: BSP CO., LTD., Anyang-si (KR); JOONGWOO M-TECH CO., LTD., Ansan-si (KR)

(21) Appl. No.: 17/000,380

(22) Filed: Aug. 24, 2020

(30) Foreign Application Priority Data
Oct. 22, 2019 (KR) 10-2019-0131323

(51) Int. Cl. C03C 23/00; B23K 26/40; B23K 26/38; C03C 15/00

(52) U.S. Cl. CPC C03C 23/0025; B23K 26/40; B23K 2103/54; C03C 15/00; B23K 26/38

(57) ABSTRACT

A crack-free glass substrate cutting and thinning method, includes: an internal deformation line formation step in which an internal deformation line is formed inside a glass substrate at a predetermined distance from a surface of the glass substrate; a surface etching step in which the glass substrate is thinned by immersing the glass substrate in an etching solution such that a portion of the surface of the glass substrate, at which the internal deformation line is not formed, is etched and removed at a first etching rate; and an etch-cutting step in which, with the glass substrate immersed in the etching solution, the internal deformation line is etched and removed at a second etching rate higher than the first etching rate such that the glass substrate is cut along the internal deformation line.

### FIELD

The present invention relates to a crack-free glass substrate cutting and thinning method and, more particularly, to a crack-free glass substrate cutting and thinning method which can prevent occurrence of micro- or nanoscale crack marks on a cut surface.

### BACKGROUND

Generally, mechanical cutting, such as scribing and blade dicing, laser-based cutting, and chemical cutting using an alkaline or acidic solution, such as KOH and HF, are used to cut and separate brittle substrates, such as glass, silicon, and ceramic substrates.

Mechanical cutting has drawbacks of requirement for additional chip removal and cleaning processes after machining due to formation of a large amount of chips during machining; wear of a tool caused by physical contact between the tool and a substrate; and subsequent damage to a substrate due to microcracks remaining on a cut surface after machining.

There are several laser-based cutting methods commonly used in the art. Thereamong, there is a method of cutting a substrate by removing a portion of the substrate using a laser beam having a wavelength corresponding to an absorption band of the substrate.

In this method, since the quantity of a substrate material that can be removed by one shot of a laser beam is limited, cutting is generally performed by removing the substrate material along the depth of the substrate through several scan operations. Accordingly, this method has drawbacks of long machining time and inevitable thermal damage to a workpiece due to formation of a wide heat-affected zone (HAZ) around the workpiece. In addition, the heat-affected zone can change physical properties of a workpiece or can leave residual stress in the workpiece, causing deterioration in strength or uniformity of a substrate.

In another laser-based cutting method, a laser beam is used to generate and propagate cracks rather than to physically remove a substrate material, so as to help cut a substrate or is used to directly cut the substrate. Here, the laser beam is used to increase the temperature of a desired area in the substrate. As the substrate is cooled, tensile force is generated, thereby allowing the substrate to be cut through generation and propagation of cracks.

Despite an advantage of crack-free cutting, chemical cutting using a chemical solution such as KOH and HF has drawbacks of requirement for very complicated processes including application, exposure and cleaning to use a photoresist for masking; and long glass dissolution time.

FIG. 1 is a view of an exemplary typical laser-based glass substrate cutting method and FIG. 2 is a view of a cut surface of a glass substrate obtained by the glass substrate cutting method of FIG. 1.

First, spots 20 corresponding to a cutting line are formed by irradiating a glass substrate 10 with a laser beam, as shown in FIG. 1(a). Then, as the glass substrate 10 is cooled, cracks 30 are propagated to connect the spots 20 to one another, as shown in FIG. 1(b). As a result, cutting of the glass substrate 10 is achieved.

However, the glass substrate cut by this method has crack marks 40 on a cut surface thereof, as shown in FIG. 2. Accordingly, an additional edge grinding process is required to remove the crack marks 40, thereby increasing the processing time.

In addition, since it is difficult to apply such an edge grinding process to an ultra-thin glass substrate, which has a thickness of 100 μm or less, this method has a problem of difficulty in removing crack marks on a cut surface of such an ultra-thin glass substrate.

Further, since it is very difficult to manufacture a glass substrate having a thickness of 100 μm or less, the price of such a glass substrate tends to soar with decreasing thickness thereof.

### RELATED LITERATURE

<Patent Document>

(Patent Document 1) Korean Patent Publication No. 2009-0079342 (published on Jul. 22, 2009)

### SUMMARY

Embodiments of the present invention have been conceived to solve such a problem in the art and it is an aspect of the present invention to provide a crack-free glass substrate cutting and thinning method which allows improvement in cut surface quality, can achieve both thinning and cutting of a glass substrate, and can prevent contamination of a surface of the glass substrate through a process in which an internal deformation line is formed inside the glass substrate through irradiation with a laser beam, followed by immersing the glass substrate in an etching solution.

In accordance with an aspect of the present invention, a crack-free glass substrate cutting and thinning method includes: an internal deformation line formation step in which an internal deformation line is formed inside a glass substrate at a predetermined distance from a surface of the glass substrate by irradiating the glass substrate with a laser beam at an intensity not exceeding an ablation threshold of the glass substrate; a surface etching step in which the glass substrate is thinned by immersing the glass substrate in an etching solution such that a portion of the surface of the glass substrate, at which the internal deformation line is not formed, is etched and removed at a first etching rate; and an etch-cutting step in which, with the glass substrate immersed in the etching solution, the internal deformation line is etched and removed at a second etching rate higher than the first etching rate such that the glass substrate is cut along the internal deformation line.

A thickness of the portion of the surface of the glass substrate removed in the surface etching step may be smaller than a thickness of a portion with the internal deformation line formed thereon, which is removed in the etch-cutting step.

In the internal deformation line formation step, phase transition from an α-phase to a β-phase may occur in a region inside the glass substrate corresponding to the internal deformation line.

In the internal deformation line formation step, the internal deformation line may be formed by inducing phase transition of a region inside the glass substrate ranging from an upper end of the internal deformation line to a lower end thereof without moving a focus of the laser beam.

In the internal deformation line formation step, the internal deformation line may be formed by inducing phase transition of a region inside the glass substrate corresponding to the internal deformation line while continuously moving a focus of the laser beam from an upper end of the region to a lower end thereof.

The glass substrate may have a thickness of 100 μm or less.

A crack-free glass substrate cutting and thinning method according to the present invention allows obtainment of a clean cut surface and thus improvement in cut surface quality while achieving both thinning and cutting of a glass substrate.

In addition, the crack-free glass substrate cutting and thinning method according to the present invention can prevent contamination of a surface of a glass substrate.

Further, the crack-free glass substrate cutting and thinning method according to the present invention can reduce the time required for the overall thinning and cutting process.

### DRAWINGS

FIG. 1 is a view of an exemplary typical laser-based glass substrate cutting method.

FIG. 2 is a view of a cut surface of a glass substrate obtained by the glass substrate cutting method of FIG. 1.

FIG. 3 is a flowchart of a crack-free glass substrate cutting and thinning method according to one embodiment of the present invention.

FIG. 4 is a schematic view illustrating the crack-free glass substrate cutting and thinning method of FIG. 3.

FIG. 5 is a view illustrating an internal deformation line formation step of the crack-free glass substrate cutting and thinning method of FIG. 3.

FIG. 6 is a view showing contamination of a surface of a glass substrate upon forming a deformation line over the entire region inside the glass substrate.

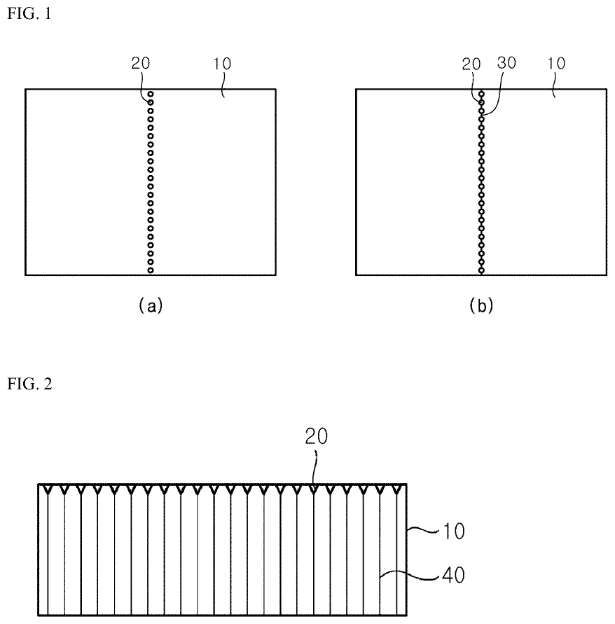

### DETAILED DESCRIPTION

Hereinafter, embodiments of a crack-free glass substrate cutting and thinning method according to the present invention will be described with reference to the accompanying drawings.

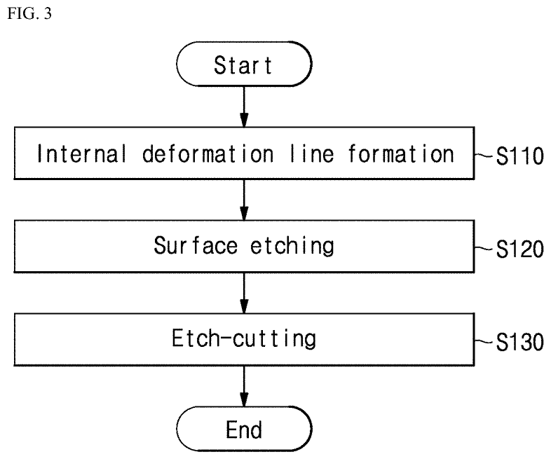

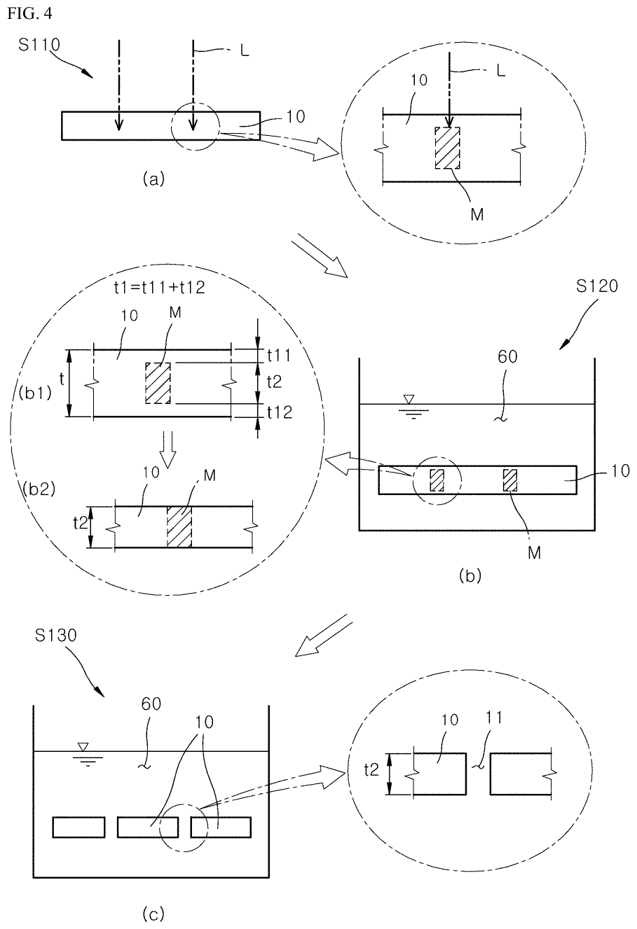

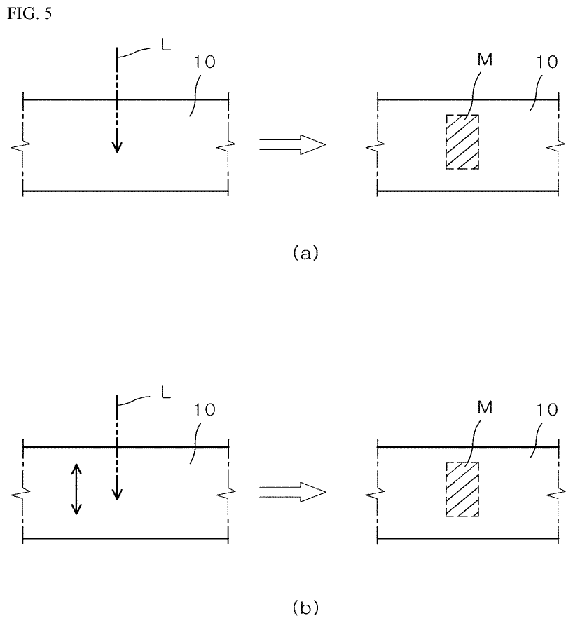

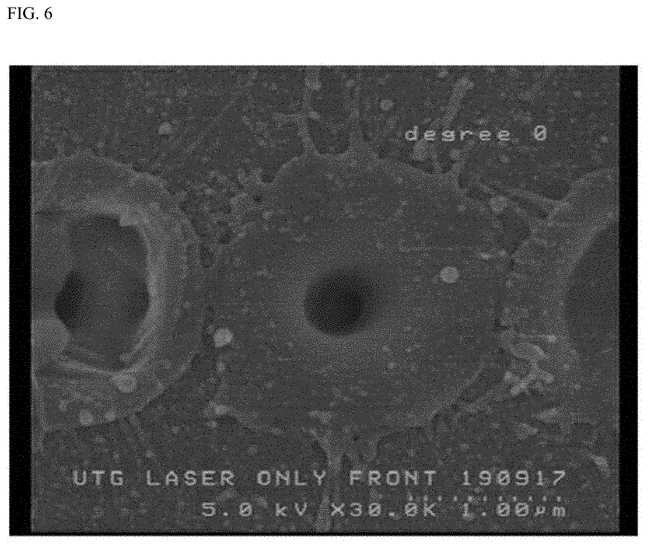

FIG. 3 is a flowchart of a crack-free glass substrate cutting and thinning method according to one embodiment of the present invention, FIG. 4 is a schematic view illustrating the crack-free glass substrate cutting and thinning method of FIG. 3, and FIG. 5 is a view illustrating an internal deformation line formation step of the crack-free glass substrate cutting and thinning method of FIG. 3.

Referring to FIG. 3 to FIG. 5, the crack-free glass substrate cutting and thinning method according to this embodiment is a method of cutting and thinning a glass substrate with occurrence of micro- or nanoscale crack marks on a cut surface, and includes an internal deformation line formation step S110, a surface etching step S120, and an etch-cutting step S130.

In the internal deformation line formation step S110, an internal deformation line M is formed by irradiating a glass substrate 10 with a laser beam L at an intensity not exceeding an ablation threshold of the glass substrate 10.

As the laser beam L radiated to the glass substrate 10 in the internal deformation line formation step S110, an ultrashort laser beam including a picosecond-pulse laser beam and a femtosecond-pulse laser beam may be used.

Upon irradiation of the glass substrate 10 with the picosecond-pulse laser beam or the femtosecond-pulse laser beam, no melt layers are formed in regions other than an irradiated region and any substrate material around the irradiated region does not undergo alteration. That is, irradiation with the picosecond-pulse laser beam or the femtosecond-pulse laser beam allows thermal energy to be effectively applied only to the irradiated region, thereby allowing the internal deformation line M to be clearly distinct from the other portions of the glass substrate 10.

Referring to FIG. 4(a), the internal deformation line M according to this embodiment is formed inside the glass substrate 10 at a predetermined distance from a surface of the glass substrate 10. Preferably, the internal deformation line M is formed inside the glass substrate 10 to be separated a predetermined distance from an upper surface of the glass substrate 10 and separated a predetermined distance from a lower surface of the glass substrate 10.

Upon irradiation of the glass substrate 10 with the laser beam L, a region irradiated with the laser beam L may undergo phase transition from an α-phase to a β-phase.

In a region inside the glass substrate corresponding to the internal deformation region M, permanent physicochemical structural deformation occurs by a nonlinear photoionization mechanism induced by the ultrashort laser beam. A region on which the laser beam L is focused becomes rich in Si and dense and undergoes alteration in index of refraction and the like.

The internal deformation line M formed through irradiation with the ultrashort laser beam may be etched by an alkaline or acidic chemical solution 20 to 300 times as fast as the other regions of the glass substrate 10, which do not undergo deformation. Here, a rate at which the internal deformation line is etched may be adjusted by various parameters, such as laser intensity, pulse duration, repetition rate, wavelength, focal length, scan rate, and concentration of the chemical solution.

In one embodiment, the internal deformation line M may be formed by inducing phase transition of a region inside the glass substrate ranging from an upper end of the internal deformation line M to a lower end thereof without moving a focus of the laser beam, as shown in FIG. 5(a).

In another embodiment, the focus of the laser beam may be continuously moved from an upper end of a region inside the glass substrate corresponding to the internal deformation region M to a lower end of the region, as shown in FIG. 5(b). That is, the internal deformation line M may be formed by inducing phase transition of the entire region corresponding to the internal deformation line M while moving the focus of the laser beam in a thickness direction of the glass substrate 10.

In the surface etching step S120, the glass substrate 10 is thinned by immersing the glass substrate 10 in an etching solution 60 such that a portion of the surface of the glass substrate, at which the internal deformation line M is not formed, is etched and removed at a first etching rate.

The etching solution 60 used in the surface etching step S120 and the etch-cutting step S130 described below may be a chemical etching solution, such as fluorine (HF), nitric acid (HNO₃), or potassium hydroxide (KOH).

Referring to FIG. 4(b), upon immersing the glass substrate 10 in the etching solution 60 in the surface etching step S120, the thickness of the glass substrate 10 is reduced. That is, with removal of a portion corresponding to a first thickness t1 in the surface etching step S120, the thickness of the glass substrate is changed from a pre-surface etching thickness t to a post-surface etching thickness t2.

Here, when the thicknesses of non-deformed portions inside the glass substrate 10 above and below the internal deformation line M are t11 and t12, respectively, the first thickness t1, that is, the thickness of a portion of the glass substrate 10 removed in the surface etching step S120 means the sum of t11 and t12.

As the glass substrate 10 is thinned to the thickness t2 through the surface etching step S120, the internal deformation line M formed inside the glass substrate 10 contacts the etching solution 60.

In the etch-cutting step S130, with the glass substrate 10 immersed in the etching solution 60, the internal deformation line M is etched and removed at a second etching rate higher than the first etching rate such that the glass substrate 10 is cut along the internal deformation line M.

Upon immersing the glass substrate 10 in the etching solution 60, the second etching rate at which a portion (β-phase) of the glass substrate 10 having the internal deformation line M thereon is etched may be about 100 times or more the first etching rate at which the other portions (α-phase) are etched.

Accordingly, upon immersing the glass substrate 10 with the internal deformation line M formed therein in the etching solution 60, a portion with the internal deformation line M formed thereon is mainly etched, whereas the other portions are hardly etched. Accordingly, the glass substrate 10 can be separated into a plurality of glass substrates as the portion having the internal deformation line M formed thereon (designated by 11 in FIG. 4(c)) is etched and removed.

A typical glass substrate cutting method based on chemical dissolution using photoresist cuts a glass substrate with a large taper angle, whereas a glass substrate cutting method as in the present invention, in which a glass substrate is cut by etching an internal deformation line M formed through irradiation with a focused ultrashort laser beam, can obtain a cut surface with a cut angle close to 0 degrees. In addition, the cut surface of the glass substrate 10 obtained by the method according to the present invention can be clean without crack marks.

Preferably, the first thickness t1, that is, the thickness of a portion of the surface of the glass substrate 10, which is removed in the surface etching step S120 according to this embodiment, is smaller than the second thickness, that is, the thickness of a portion with the internal deformation line M formed thereon, which is removed in the etch-cutting step S130. Here, the second thickness t2 means the thickness of the internal deformation line M removed by the etching solution 60 in the etch-cutting step S130 and is substantially the same as the thickness of the glass substrate 10, from which a portion of the surface has been removed through the surface etching step S120.

Since the first etching rate at which the glass substrate in the α-phase is etched is much lower than the second etching rate at which the glass substrate in the β-phase is etched, it is possible to reduce the time required for the overall thinning and cutting process by allowing a portion in the α-phase (a portion of the surface of the glass substrate 10) to have a smaller thickness than a portion in the β-phase (a portion with the internal deformation line M formed thereon).

Here, the glass substrate 10 may be an ultra-thin glass substrate that has a thickness of 100 μm or less. The crack-free glass substrate cutting and thinning method according to the present invention can also cut such an ultra-thin glass substrate such that the glass substrate has a clean cut surface.

The crack-free glass substrate cutting and thinning method according to the present invention allows obtainment of a clean cut surface and thus improvement in cut surface quality while achieving both thinning and cutting of a glass substrate, through a process in which a deformation line is formed inside the glass substrate through irradiation with a laser beam, followed by immersing the glass substrate in an etching solution.

FIG. 6 is a view showing contamination of a surface of a glass substrate upon forming a deformation line over the entire region inside the glass substrate.

Referring to FIG. 6, when a deformation line in the β-phase is formed across the entire thickness of the glass substrate 10, a glass substrate material melted by a laser beam in the step of forming the deformation line can be released onto the surface of the glass substrate 10, thereby causing contamination of the glass substrate 10.

However, when the internal deformation line M is formed inside the glass substrate 10, as in the present invention, non-deformed portions of the surface of the glass substrate above and below the internal deformation line M can prevent release of a melted glass substrate material from the inside of the glass substrate, thereby preventing contamination of the surface of the glass substrate 10.

Accordingly, the crack-free glass substrate cutting and thinning method according to the present invention can prevent contamination of a surface of a glass substrate by forming an internal deformation line inside the glass substrate through irradiation with a laser beam, followed by etching the internal deformation line.

In addition, the crack-free glass substrate cutting and thinning method according to the present invention can reduce the time required for the overall thinning and cutting process by allowing a portion in the α-phase to have a smaller thickness than a portion in the β-phase.

While certain embodiments have been described, it should be understood that these embodiments are presented by way of example only and are not intended to limit the scope of the present invention and the embodiments described herein may be embodied in a variety of other forms. In addition, it should be understood that various modifications, variations, and alterations can be made by those skilled in the art without departing from the spirit and scope of the present invention.

### LIST OF REFERENCE NUMERALS

10: Glass substrate
60: Etching solution
L: Laser beam
M: Internal deformation line
S110: Internal deformation line formation step
S120: Surface etching step
S130: Etch-cutting step

What is claimed is:

1. A crack-free glass substrate cutting and thinning method comprising:
an internal deformation line formation step in which an internal deformation line is formed inside a glass substrate at a predetermined distance from a surface of the glass substrate by irradiating the glass substrate with a laser beam at an intensity not exceeding an ablation threshold of the glass substrate;
a surface etching step in which the glass substrate is thinned by immersing the glass substrate in an etching solution such that a portion of the surface of the glass substrate, at which the internal deformation line is not formed, is etched and removed at a first etching rate; and
an etch-cutting step in which, with the glass substrate immersed in the etching solution, the internal deformation line is etched and removed at a second etching rate higher than the first etching rate such that the glass substrate is cut along the internal deformation line.

2. The crack-free glass substrate cutting and thinning method according to claim 1, wherein a thickness of the portion of the surface of the glass substrate removed in the surface etching step is smaller than a thickness of a portion with the internal deformation line formed thereon, which is removed in the etch-cutting step.

3. The crack-free glass substrate cutting and thinning method according to claim 1, wherein, in the internal deformation line formation step, phase transition from an α-phase to a β-phase occurs in a region inside the glass substrate corresponding to the internal deformation line.

4. The crack-free glass substrate cutting and thinning method according to claim 3, wherein, in the internal deformation line formation step, the internal deformation line is formed by inducing phase transition of a region inside the glass substrate ranging from an upper end of the internal deformation line to a lower end thereof without moving a focus of the laser beam.

5. The crack-free glass substrate cutting and thinning method according to claim 3, wherein, in the internal deformation line formation step, the internal deformation line is formed by inducing phase transition of a region inside the glass substrate corresponding to the internal deformation line while continuously moving a focus of the laser beam from an upper end of the region to a lower end thereof.

6. The crack-free glass substrate cutting and thinning method according to claim 1, wherein the glass substrate has a thickness of 100 μm or less.
